(19) United States
(12) Patent Application Publication
(10) Pub. No.: US 2006/0049931 A1
(43) Pub. Date: Mar. 9, 2006

(54) Crime preventing device

(76) Inventor: Minoru Sugimura, Osaka (JP)

Correspondence Address: FLYNN, THIEL, BOUTELL & TANIS, P.C., 2026 Rambling Road, Kalamazoo, MI, 49008-1631, US

(21) Appl. No.: 11/220,239

(22) Filed: Sep. 6, 2005

(30) Foreign Application Priority Data
Sep. 7, 2004 (JP) 2004-259372

(51) Int. Cl. G08B 23/00

(52) U.S. Cl. 340/500; 340/573.1

(57) ABSTRACT

This invention provides a crime preventing device capable of repelling a criminal and blocking an escape. A remote-controllable liquid sprayer 3 is incorporated in the inside 2 of a counter 1 and a nozzle 4 of the liquid sprayer 3 is disposed on the bottom of a front face 5 of the counter 1, the liquid sprayer 3 being charged with spraying liquid containing odor component. By spraying the odor component over the foot portion of a criminal, the criminal is repelled by that odor so as to block execution of a crime and the odor sticks to the trousers or shoes which the criminal cannot throw away easily during an escape securely.

### BACKGROUND OF THE INVENITON

1. Field of the Invention

The present invention relates to a crime preventing device installed in a shop.

2. Description of Related Art

Conventionally, a shop run at midnight, for example, convenience store, is likely to be a target of a burglar and as a crime preventing means, a color ball has been used.

As for the color ball, colored fluorescent paint is sealed in a ball which ruptures easily when it receives an impact and this ball is thrown to a burglar running away so that his clothes is stained with color thereby facilitating pursuit and arresting. Providing a shop with the color balls aims at suppressing occurrence of crimes.

This inventor has not researched on preceding technologies concerned at a stage of application and therefore, does not know any preceding technical documents which should be mentioned here.

The color ball cannot be used until a crime occurs and during proceeding of a crime, it is not effective. Further it is not easy to hit the color ball on a burglar running randomly and the criminal easily thinks that even if his clothes is hit by the ball, he can hide himself in crowds by taking it off and throwing away. Thus, the color ball is low in psychologically-effective crime suppression and therefore, a more effective crime preventing means has been demanded.

### SUMMARY OF THE INVENTION

In views of the above-described problems, the present invention provides a crime preventing device in which a remote-controllable liquid sprayer is incorporated inside a shop counter and a nozzle of the liquid sprayer is disposed on the bottom of the front face of the counter, the liquid sprayer being charged with liquid containing odor component, so as to spray that odor component liquid to the feet of a criminal, repelling the criminal with the odor and preventing a crime, so that trousers or shoes of the criminal which may not be thrown away easily during runaway, are stained completely with the odor contained liquid.

Generally, a burglar stands opposite a shop clerk across the counter to menace the clerk to obey his request after forcing his way into the shop. Because according to the present invention, the remote-controllable liquid sprayer is installed inside the counter, the criminal approaches the nozzle of the liquid sprayer without taking any care thereof.

Because the nozzle of the liquid sprayer is disposed on the bottom portion of the counter and the liquid sprayer is charged with spraying liquid containing odor component, if the liquid sprayer is operated under remote control, the odor component is sprayed to the foot portion of a criminal, so that he is shocked and embarrassed with that odor and he cannot help run away giving up an execution of the crime.

However, the criminal cannot throw away his trousers or shoes during escape because the odor component sticks to him. Alternatively, he must gain new trousers or shoes to throw away them. That is, the criminal must take time and labor, which hampers his escape and eliminates a will of escaping.

Even if the criminal hides himself at any place, a pursuit with a police dog is very easy and he can be found out in a short time.

Therefore, according to the present invention, not only the criminal can be repelled but also even if he escapes, he can be found out securely thereby making it possible to raise the ratio of criminal arresting.

### BRIED DESCRIPTION OF THE DRAWINGS

FIG. 1 is a schematic diagram of a crime preventing device of the present invention.

### DESCRIPTION OF THE PREFERRED EMBODIMENTS

Hereinafter, an embodiment of the present invention will be described with reference to the accompanying drawing.

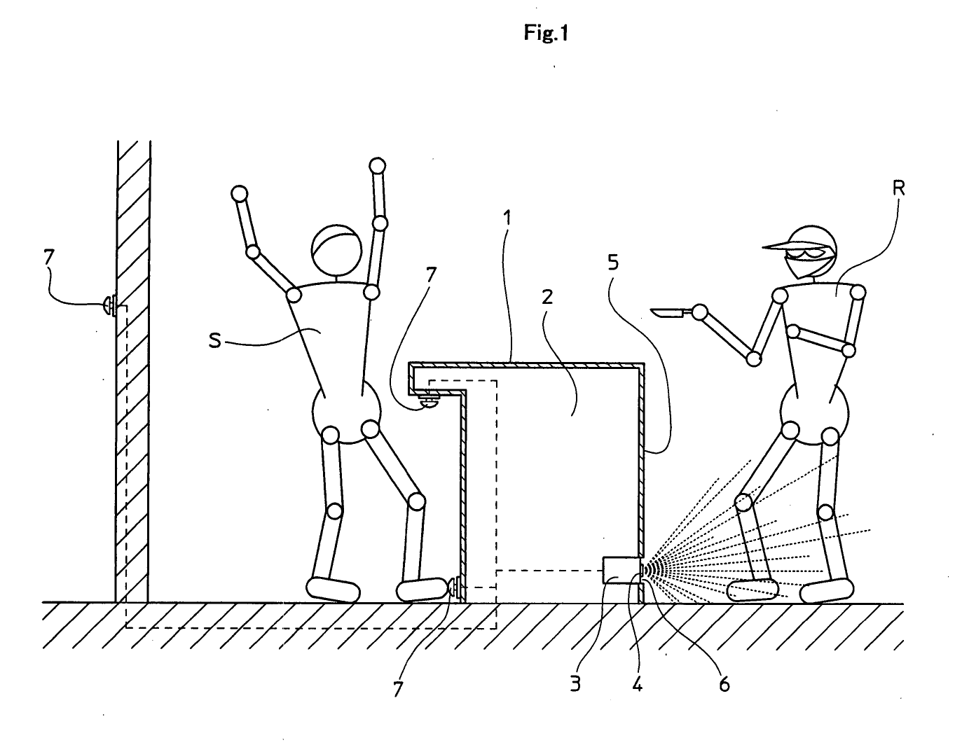

As shown in FIG. 1, the crime preventing device of the present invention is provided inside a convenience store, bank and the like and a liquid sprayer 3 is installed inside a counter 2 which partitions between a customer and a shop clerk when the customer is treated. A nozzle 4 of the liquid sprayer 3 is disposed in an opening 6 provided on the bottom of the front face 5 (customer side) of the counter 1, the liquid sprayer 3 being charged with liquid containing odor component.

Although not shown here, it is permissible to provide the opening 6 with a remote-controllable cover or a shield on the top portion of the opening 6 in order to prevent the nozzle 4 from being seen conspicuously when it is not employed.

Although the liquid sprayer 3 needs to be capable of spraying the liquid under remote control, its operating type, such as wired type or radio type can be selected appropriately and an operation switch 7 may be installed at an appropriate position. For example, it may be provided on an upper part or a bottom part of the rear side (clerk side) of the counter 1 so that a clerk S standing behind the counter 1 can operate it. Alternatively, the operation switch may be provided at a hidden place away from the counter so that other clerk can operate it without attracting attention of a burglar R.

The odor component contained in the spraying liquid may be of any type as long as it generates an odor which human dislikes and maintains its performance for long hours and for example, methyl mercaptan (source of rotting smell of onion), isovaleric acid (source of socks smell) and the like can be mentioned. By mixing other source of stimulant smell such as acetic acid with these, its criminal repelling force is intensified.

What is claimed is:

1. A crime preventing device wherein a remote-controllable liquid sprayer is incorporated inside a counter and a nozzle of the liquid sprayer is disposed on a bottom portion of the front face of the counter, the liquid sprayer being charged with spraying liquid containing odor component.
